(19) United States
(12) Patent Application Publication
(10) Pub. No.: US 2005/0211795 A1
(43) Pub. Date: Sep. 29, 2005

(54) Delivering device

(76) Inventors: Hiromichi Ueda, Tokyo (JP); Kazuhiro Ichikawa, Tokyo (JP)

Correspondence Address: BIRCH STEWART KOLASCH & BIRCH, PO BOX 747, FALLS CHURCH, VA, 22040-0747, US

(21) Appl. No.: 10/515,282

(22) PCT Filed: Aug. 5, 2003
(86) PCT No.: PCT/JP03/09920

§ 371 Date: Nov. 22, 2004

(30) Foreign Application Priority Data
Aug. 26, 2002 (JP) 2002-244789
Aug. 26, 2002 (JP) 2002-244790
Aug. 26, 2002 (JP) 2002-244791
Aug. 26, 2002 (JP) 2002-244792
Aug. 26, 2002 (JP) 2002-244793

(51) Int. Cl. B05B 9/03; A62C 13/62; A62C 35/58; A62C 11/00; B05B 7/32

(52) U.S. Cl. 239/302; 239/333; 239/337

(57) ABSTRACT

A liquid housed inside a container 2 is discharged by pump means 4 included in the container 2. The container 2 includes a hollow part 6 for housing the liquid, and an elastic sheet member 5 for blocking the hollow part 6. The elastic sheet member 5 expands toward the inside of the hollow part 6 as the liquid inside the hollow part 6 is decreased by being discharged.

### TECHNICAL FIELD

The present invention relates to a delivering device for discharging a liquid such as an aromatic, a perfume and a hair styling liquid, which is stored inside a container, by a pump attached to a top portion of the container.

### BACKGROUND ART

A delivering device 50 shown in FIG. 17 is conventionally known. The delivering device 50 is comprised of a container 52 in a cylinder shape, which includes an opening portion 51 at a bottom portion, pump means 53 attached to a top portion 52a of the container 52, and a gasket 54 provided slidably along an inner surface of a circumferential wall of the container 52. The pump means 53 generates a pump action by repeating up-and-down movement by pressing a pressing portion 55, then sucks a liquid, which is housed inside the container 52, from a suction port 56 and discharges the liquid from a discharge port 57 provided at the pressing portion 55.

The gasket 54 is formed of a synthetic resin having proper elasticity, and includes a pressure contact portion 58, which is formed into a thin tongue shape, at an outer circumferential side. The gasket 54 is inserted into the container 52 from the bottom opening portion 51 of the container 52, and the pressure contact portion 58 is in pressure contact with the inner surface of the circumferential wall of the container 52, whereby the gasket 54 tightly seals the bottom opening portion 51.

In the conventional delivering device 50 of the above-mentioned structure, the liquid is discharged by operating the pump means 53, and the gasket 54 moves toward the top portion 52a of the container 52 following a decrease of the liquid inside the container 52. Due to this, the liquid can be discharged without introducing air into the container 52, and deterioration or the like of the liquid stored inside the container 52 can be prevented. The delivering device 50 can prevent deterioration or the like of the liquid caused by contact with air, and therefore the delivering device 50 is suitable for housing a perfume and cosmetics.

However, in the conventional discharge container 52, sealability is reduced when the gasket 54 is deteriorated, and there arises the fear of the liquid inside the container 52 leaking out.

In the delivering device 50 of this kind, the container 52 is usually formed of an opaque material, but in order to confirm the residual amount or the like of the housed liquid, there may be cases where the container is formed from a transparent material. However, if the container 52 is formed of a transparent material, the gasket 54 becomes visible, and there arises the fear that the beauty of the appearance is spoiled.

In the delivering device 50 of this kind, the sealed state inside the container 52 has to be maintained by the gasket 54 moving inside the container 52, and therefore the shape of the inside of the container 52 needs to be formed into a circular cylinder shape with its inner diameter in the moving range of the gasket 54 being constant. When the container 52 of this kind is used as a container for storing a perfume and cosmetics, it is considered to form the outer shape of the container 52 into the shape other than the cylindrical shape to improve its aesthetic impression, but there is the disadvantage that the inside of the container cannot be formed into any shape other than the circular cylinder shape because the gasket 54 is moved in the sealed state.

Further, it is necessary to form the aforementioned gasket 54 to be comparatively large to prevent reduction in sealability, poor movement and the like due to inclination of the gasket 54 with respect to the axis line of the container 52, and there is the disadvantage that the capacity of the container 52 becomes smaller in comparison to the outer appearance.

To eliminate the above disadvantages, the present invention has its object to provide a delivering device which is capable of discharging the liquid inside the container smoothly while securely maintaining a sealed state of the container without being influenced by the shape of the container and obtaining the sufficient capacity inside the container, and capable of improving the aesthetic impression of the appearance by making it possible to adopt a container with high quality design.

### DISCLOSURE OF INVENTION

The present invention is a delivering device for discharging a liquid housed in a container by pump means provided to the container, and is characterized in that the aforementioned container comprises a hollow part for housing the aforesaid liquid and an elastic sheet member for blocking the hollow part, and the elastic sheet member is expandable toward the inner side of the hollow part corresponding to the decrease of the liquid inside the hollow part when liquid is discharged by said pump means.

In the delivering device of the present invention, a bottom portion of the aforementioned container is blocked with the aforementioned elastic sheet member in place of a gasket, thus making it possible to obtain excellent sealability. Since the delivering device of the present invention does not include the gasket, the gasket is not visible even if the aforementioned container is made transparent, and thus aesthetic impression of the appearance is not impaired.

In the delivering device of the present invention, the hollow part of the aforementioned container is blocked by the aforementioned elastic sheet member in place of the gasket as in the prior art, thus making it possible to obtain excellent sealability. The elastic sheet member expands in a dome shape toward the inside the hollow part following the decrease in the liquid inside the aforementioned hollow part, and the liquid inside the hollow part can be smoothly discharged without being brought into contact with air.

In the present invention, the elastic sheet member is characterized by being provided at the bottom side of the aforementioned container to block the aforementioned hollow part, and is expandable along an inner circumference wall surface of the hollow part following the decrease of the liquid inside the hollow part.

The aforementioned elastic member expands in a direction of a top portion in close contact with the inner surface of the circumference wall in the circular cylinder shape of the container following the decrease of the liquid inside the aforementioned container, and in this situation, the inner circumferential part of the elastic sheet member expands in the dome shape in the direction of the top portion of the aforementioned container. The elastic sheet member abuts against the inner circumference wall surface of the hollow part when the elastic sheet member expands, and therefore the liquid is prevented from remaining in a clearance between the expanded elastic sheet member and the inner circumference wall surface of the hollow part, thus making it possible to discharge efficiently.

It is preferable that the aforementioned elastic sheet member in the present invention is formed by a material which provides sufficient expansion amount and has high durability. Thus, as one of the preferable materials for the aforementioned elastic sheet member, hydrogenated styrene elastomer can be cited. Hydrogenated styrene elastomer has an extremely high degree of stretching, and it can be expanded so largely inside the hollow part of the container as not to cause breakage or the like.

In the present invention, the aforementioned pump means is characterized by comprising a pump portion which is located inside the container for sucking up the liquid inside the container, and a pressing portion which comprises a discharge port for discharging the liquid sucked up by the pump portion and actuating the pump portion by pressing operation, the container is characterized by comprising a pump mounting portion for mounting the aforementioned pump means, and the pump mounting portion is characterized by comprising a pump housing portion for housing the pump portion of the pump means, the pump portion being located inside the container, in a position so as to prevent the elastic sheet member expanding inside the hollow part from coming into contact with the pump portion. According to this, the liquid inside the container can be smoothly discharged without the aforementioned expanding elastic sheet member blocking the pump portion.

The aforementioned container is characterized by comprising a lid member for covering an outer side of the aforementioned elastic sheet member, and the lid member is characterized by comprising a communication hole portion for communicating with an outer side of the container and a side opposing the elastic sheet member so as to pass air freely. The aforementioned lid member can prevent contact with the elastic sheet member from the outside by covering the outer side of the aforementioned elastic sheet member, and accidental damage to the elastic sheet member can be prevented. Since the aforementioned communication hole portion is provided at the lid member, air is smoothly introduced into a space between the elastic sheet member and the lid member via the communication hole portion when the elastic sheet member expands into the hollow part following the decrease of the liquid inside the container, and the liquid inside the hollow part can be smoothly discharged without hindrance of the expansion of the elastic sheet member by the lid member.

Since the shape of the aforementioned dome form of the aforementioned expanded elastic sheet member is visually beautiful, the aforementioned expanded elastic sheet member can be made visible by forming the aforementioned container of a transparent material, and thus excellent aesthetic impression of the appearance can be obtained.

As described above, by being providing with the aforementioned elastic sheet member, the delivering device of the present invention can smoothly discharge the liquid inside the container while securely keeping the sealed state of the container without being influenced by the shape of the hollow part of the container. As the shape of the hollow part of the container, specifically, a circular cylinder shape or a polygonal column shape can be adopted. The shape of the aforementioned hollow part can be formed into a circular cone shape or a polygonal pyramid shape, which is gradually widened toward the bottom portion. In the present invention, when the aforementioned elastic sheet member blocks a part of the aforementioned hollow part and expands in a substantially spherical shape toward the inside of the hollow part as the liquid inside the hollow part is decreased by being discharged, the aforementioned container can be formed such that a shape of the aforementioned hollow part is formed into a substantially spherical shape corresponding to an expanded shape of the aforementioned elastic sheet member.

In the present invention, the aforementioned elastic sheet member is provided at a bottom portion of the aforementioned container and formed into a shape corresponding to an inner circumference shape of the bottom portion, and at least a center portion thereof is formed to be thicker than a perimeter edge portion thereof.

The present inventor found out from various experiments that the degree of expansion of the aforementioned elastic sheet member following the decrease of the liquid inside the container becomes larger at the center portion as compared with its perimeter edge portion. Namely, the aforementioned elastic sheet member advances in expansion while gradually being brought into close contact with the inner surface of the circumferential wall of the aforementioned container from its perimeter portion in the process of expanding in a dome shape. In this situation, while the portion of the elastic sheet member, which is in close contact with the inner surface of the circumferential wall of the container, is restrained from expanding further, the center portion of the elastic sheet member is expanded comparatively strongly. If the elastic sheet member is in the state in which it is expanded to its limit, there arises the fear that the discharge by the pump means cannot be performed smoothly. Consequently, in the present invention, the elastic sheet member is formed into the shape which is thicker at least in its center portion than in its perimeter edge portion, so that the center portion of the elastic sheet member can be expanded sufficiently. According to this, the discharge by the pump means can be smoothly performed without the elastic sheet member being expanded to its limit in the center portion.

The aforementioned elastic sheet member becomes gradually thicker from each linear edge between respective corner portions to the respective corner portions corresponding to an inner circumference shape of the aforementioned hollow part, and further becomes gradually thicker from the respective corner portions toward a center portion. For example, when the flat surfaces and the corner portions inside the hollow part are compared with each other in the case where the hollow part is a polygonal column or a polygonal pyramid, the elastic sheet member comes into close contact with the flat surfaces faster than the corner portions during expansion. Thus, by making the shape of the elastic sheet member, which becomes gradually thicker, correspond to the shape of the bottom portion of the hollow part, the elastic sheet member can be expanded correspondingly to the container shape with an excellent balance being kept, and therefore the discharge by the pump means can be performed smoothly.

According to the delivering device of the present invention, the container comprises a first hollow part which is formed at a substantially upper half portion thereof and capable of housing the aforementioned liquid, and a second hollow part which is formed at a substantially lower half portion thereof and capable of housing the aforementioned liquid, the elastic sheet member for blocking the aforementioned first hollow part is provided at a border position between the aforementioned first hollow part and the aforementioned second hollow part, the aforementioned second hollow part is provided with a communication hole portion capable of introducing air into the second hollow part from an outside thereof, the liquid is housed inside the aforementioned elastic sheet member expanding into the second hollow part in the aforementioned second hollow part, and the elastic sheet member, corresponding to the decrease of the liquid inside the container, is contracted in the interior of the second hollow part, and is expanded toward a top portion of the container in the interior of the first hollow part, when the liquid is discharged by said pump means.

According to the delivering device of the present invention, the aforementioned container comprises the first hollow part and the second hollow part, and the aforementioned elastic sheet member is not provided at the bottom portion of the container, but it is provided at the border position between the first hollow part and the second hollow part. When the liquid is charged into the container, the liquid is housed inside the first hollow part, and the aforementioned elastic sheet member expands towards the second hollow part while housing the liquid to the interior of the expanded sheet member.

When the aforementioned pump means is operated and the liquid inside the container is discharged, the elastic sheet member of the second hollow part begins to contract depending on the decrease of the liquid. When the liquid inside the container is further decreased, the elastic sheet member is returned into the original shape at the border position between the first hollow part and the second hollow part, and thereafter, it expands into the first hollow part side corresponding to the further decrease of the liquid. As described above, according to the structure of the present invention, when the liquid is discharged, the elastic sheet member contracts and thereafter, it starts to expand at the border position between the first hollow part and the second hollow part, therefore making it possible to make the expansion amount of the elastic sheet member smaller as compared with the case in which the elastic sheet member is provided at the bottom portion of the container, thus making it possible to prevent accidental breakage and the like of the elastic sheet member.

Further, according to the present invention, it is not necessary to form the inner shape of the container into the cylindrical shape according to the above-described structure. Namely, since the aforementioned elastic sheet member can be deformed freely along the shape of the first hollow part and the shape of the second hollow part in accordance with its expansion, the first hollow part and the second hollow part can be formed into desired shapes, and thus the first hollow part and the second hollow part may be shaped differently.

As one mode of the container shape of the present invention, it is cited that a reduced diameter portion with a diameter being reduced is formed on an entire circumference of an inner circumference wall at a border position between the aforementioned first hollow part and the aforementioned second hollow part, and that the aforementioned elastic sheet member is provided at the reduced diameter portion. As one example of the specific shape of the inside of the container, the aforementioned first hollow part and the aforementioned second hollow part can be formed to be substantially spherical shapes with the aforementioned reduced diameter portion positioned therebetween. In this case, forming the outer shape of the container to correspond to the inner shape thereof, such as a shape where a pair of spheres is attached together can be carried out with ease, so that the container can obtain excellent aesthetic impression. The aforementioned elastic sheet member is provided at the reduced diameter portion. As a comparison, the example where the elastic sheet member is provided at the bottom portion of the container (the bottom portion of the second hollow part) will be explained hereinbelow. When the elastic sheet member, which is expanding inside the second hollow part corresponding to the decrease of the liquid, expands into the first hollow part, it comes into contact with the reduced diameter portion. Accordingly, there arise the fear that the expansion of the elastic sheet member into the first hollow part may be restrained, or the liquid may be left between the second part and the elastic member. On the other hand, according to the present invention, the elastic sheet member is provided at the aforementioned reduced diameter portion, whereby the elastic sheet member on its way to expansion does not come into contact with the reduced diameter portion, and the liquid inside the container can be discharged smoothly and reliably.

Further, even when the elastic sheet member is provided at the border position between the first hollow part and the second hollow part, the elastic sheet member gradually comes into close contact with the inner circumferential wall of the container from the peripheral thereof during its expansion, so that there arises a fear that the expansion of the elastic sheet member may be restrained in the area where the elastic sheet member is in close contact with the inner circumferential wall of the container. In order to solve such problem, the elastic sheet member is formed in such a shape that at least the center portion thereof is thicker than the perimeter edge portion, so that the center portion thereof may be expanded sufficiently. According to this, the elastic sheet member does not expand to its limit in the center portion, and thus the discharge by the pump means can be performed smoothly.

### BRIEF DESCRIPTION OF THE DRAWINGS

FIG. 1 is an explanatory sectional view showing a structure of a delivering device of a first embodiment of the present invention;

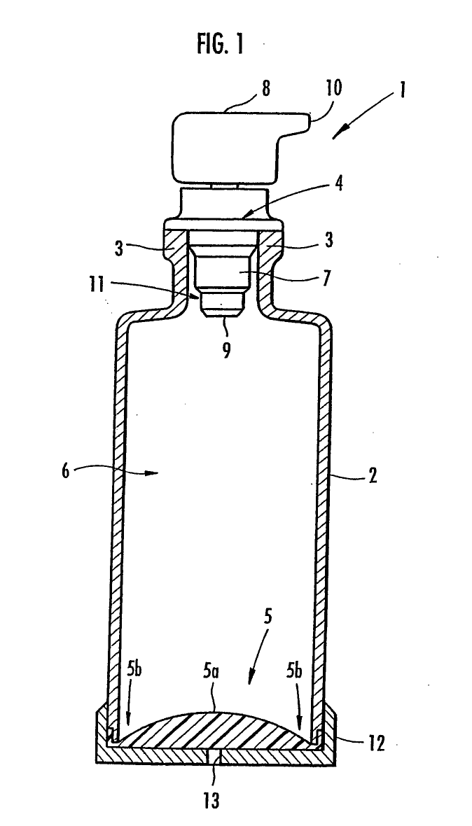

FIG. 2 is an explanatory sectional view showing an operation of the delivering device of the first embodiment;

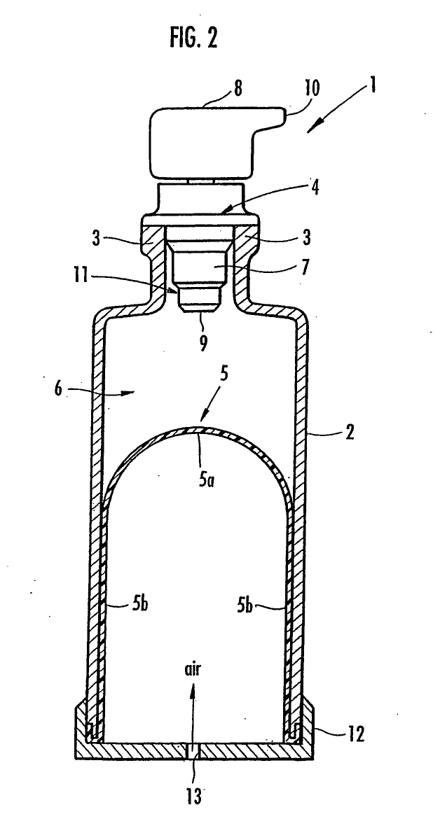

FIG. 3(A), FIG. 3(B) and FIG. 3(C) are explanatory sectional views showing a structure of an elastic sheet member shown in FIG. 1;

FIG. 4 is an explanatory sectional view showing a structure of another elastic sheet member in the first embodiment;

FIG. 5 is an explanatory perspective view showing an outer appearance of a delivering device of a second embodiment of the present invention;

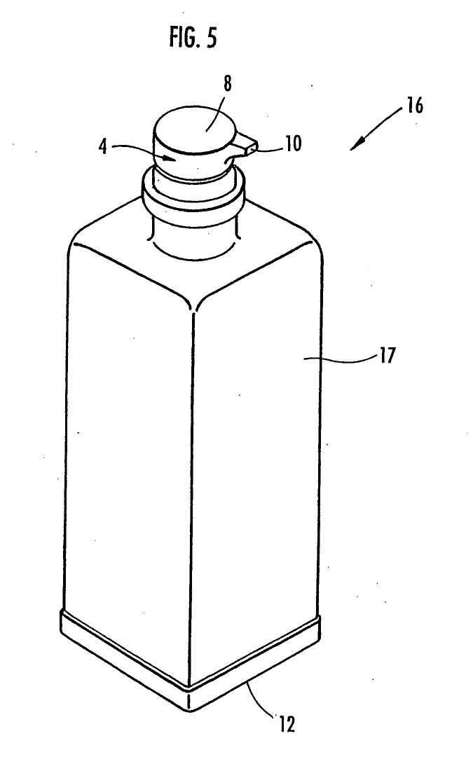

FIG. 6 is an explanatory view showing a shape of the elastic sheet member in the second embodiment;

FIG. 7 is an explanatory perspective view showing an outer shape of a delivering device of a third embodiment of the present invention;

FIG. 8 is an explanatory vertical sectional view of the delivering device of FIG. 7(1);

FIG. 9(A) and FIG. 9(B) are explanatory sectional views showing another elastic sheet member in the third embodiment;

FIG. 10 is an explanatory perspective view showing an outer shape of a delivering device of a fourth embodiment of the present invention;

FIG. 11 is an explanatory vertical sectional view showing a structure of a delivering device of a fifth embodiment;

FIG. 12(A) and FIG. 12(B) are explanatory sectional views showing another elastic sheet member in the fifth embodiment;

FIG. 13 is an explanatory vertical sectional view showing a structure of a delivering device of a sixth embodiment of the present invention;

FIG. 14 is an explanatory view showing an operation of the delivering device of the sixth embodiment;

FIG. 15(A) and FIG. 15(B) are explanatory sectional views showing another elastic sheet member in the sixth embodiment;

FIG. 16 is an explanatory sectional view showing a seventh embodiment of the present invention; and

FIG. 17 is an explanatory sectional view showing a conventional delivering device.

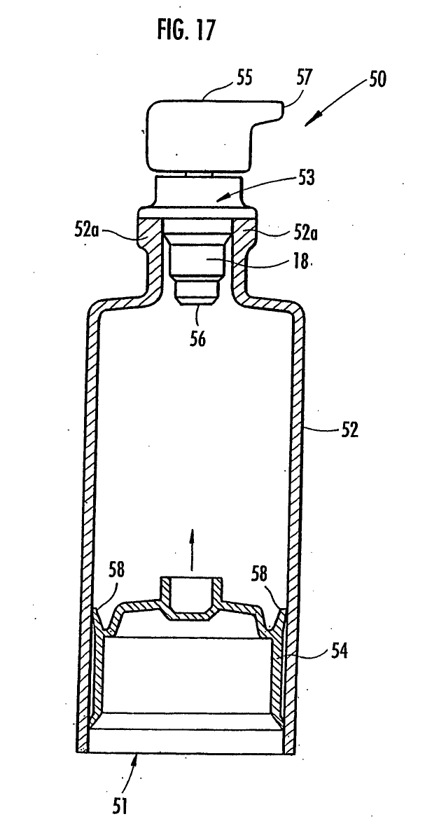

### BEST MODE FOR CARRYING OUT THE INVENTION

A first embodiment of the present invention will be explained first. A delivering device 1 of the first embodiment includes a container 2 in a cylindrical shape, pump means 4 attached to a top portion 3 of the container 2, and an elastic sheet member 5 which is fixed to a bottom portion of the container 2 and blocks the bottom portion. A hollow part 6 for housing a liquid is formed inside the container 2.

The pump means 4 includes a pump portion 7 for sucking the liquid inside the hollow part 6, and a pressing portion 8 for operating the pump portion 7 by pressing operation. The pump portion 7 is provided with a suction port 9 for sucking the liquid inside the hollow part 6, and the pressing portion 8 is provided with a discharge port 10 for discharging the liquid sucked from the suction port 9. The pump portion 7 is housed in a pump housing portion 11 in a circular cylinder shape formed at a top portion of the container 2.

The elastic sheet member 5 is formed into a shape which gradually becomes thicker toward a center portion from a perimeter edge portion. An outer perimeter edge portion of the elastic sheet member 5 is held between a bottom lid member 12 (lid member of the present invention) fitted onto an outer surface of a circumferential wall of the container 2 and the container 2 so as to provide sealability. The bottom lid member 12 includes a communication hole portion 13 for making an outside and the elastic sheet member 5 communicate with each other.

As a liquid housed inside the hollow part 6, for example, a cosmetic liquid, a liquid medicine and the like can be cited.

The delivering device 1 can discharge the liquid inside the hollow part 6 from the discharge port 10 by repeating up-and-down movement by pressing the pressing portion 8 of the pump means 4. When the liquid inside the hollow part 6 decreases due to this discharge, the inside of the hollow part 6 is applied with negative pressure, while the elastic sheet member 5 is expanded by the atmospheric pressure of air entering from the communication hole portion 13 of the bottom lid member 12.

As a result, the outer circumferential portion 5b of the elastic sheet member 5 comes into close contact with an inner surface of the circumferential wall in the circular cylinder shape of the container 2, and the inner circumferential portion 5a expands in a dome shape in a direction of the top portion 3. In this situation, expansion of the outer circumferential portion 5b of the elastic sheet member 5 is restrained by the contact friction against the inner surface of the circumferential wall of the hollow part 6, but the inner circumferential portion 5a freely expands, because it does not come into contact with the inner surface of the circumferential wall of the container 2, and is expanded to a great extent. However, in this embodiment, the inner circumferential portion 5a of the elastic sheet member 5 is formed to be thicker than the outer circumferential portion 5b, and therefore there is no fear that the inner circumferential portion 5a is broken even if it is expanded to a great extent. Since the pump portion 7 of the pump means 4 is housed in the aforementioned pump housing portion 11, the elastic sheet member 5 expanded inside the hollow part 6 is prevented from abutting against and blocking the suction port 9, and thus the liquid inside the hollow part 6 can be discharged to the last drop.

The inner circumferential portion 5a gradually becomes thinner as it is expanded further, and it is feared that the inner circumferential portion 5a may be broken by coming into contact with a protrusion and the like at the exterior of the container. However, in this embodiment, the bottom lid member 12 is placed outside the elastic sheet member 5, and therefore the bottom lid member 12 can protect the inner circumferential portion 5a of the elastic sheet member 5, which becomes thin as described above, from contacting with the protrusion and the like at the exterior of the container.

In order for the elastic sheet member to expand as described above, it is desirable that the elastic sheet member 5 is formed of a flexible material having a breaking elongation of 500 to 2000%. Since the elastic sheet member 5 directly contacts the liquid such as a cosmetic liquid and a liquid medicine housed inside the hollow part 6, it is desirable that the elastic sheet member 5 includes chemical resistance which prevents deterioration such as swelling and hardening due to the contact. Further, it is desirable that the elastic sheet member 5 does not elute its components to deteriorate color, fragrance and the like of the liquid, and conversely does not adsorb the components of the liquid.

As a material including the aforementioned desirable conditions, for example, hydrogenated styrene elastomer can be cited. When the aforementioned hydrogenated styrene elastomer is, for example, styrene-butadiene and the like or styrene-isoprene and the like, to satisfy the aforementioned conditions, it is preferable that the viscosity of 10 wt %-toluene solution (30° C.) is in the range of 1000 m P·S or more, and the content of styrene is in the range of 15 to 35 mol %, and it is more preferable that a softening agent is included.

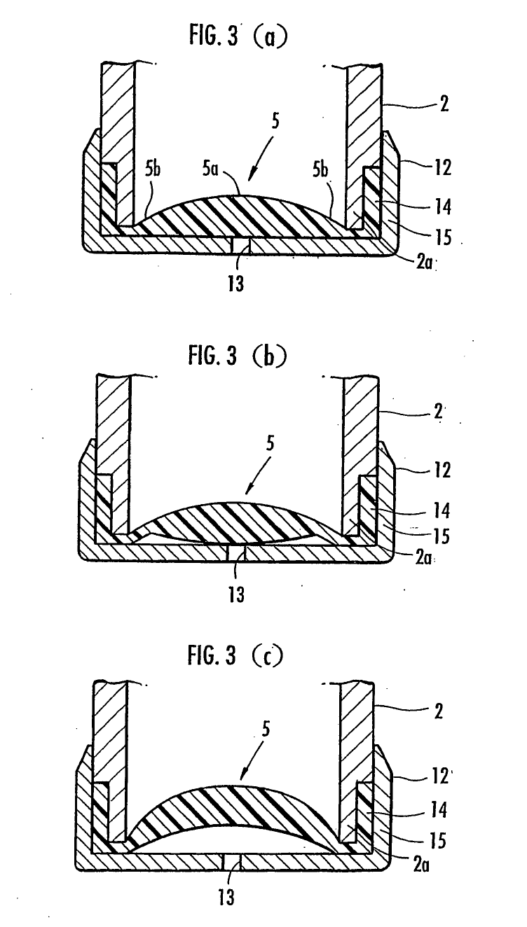

The elastic sheet member 5 is firmly fixed to the bottom portion of the container 2 by the bottom lid member 12. Namely, as shown in enlarged state in FIG. 3(A), there is provided an upright portion 14 of the elastic film member 5, which is upright along the outer circumferential edge of the elastic sheet member 5, and the upright portion 14 is held between the bottom end portion 2a of the container 2 and the circumferential wall 15 of the bottom lid member 12. Due to this, even if the elastic sheet member 5 includes high flexibility, the elastic sheet member 5 can be firmly fixed to the container 2. It is preferable that the bottom lid member 12 is adhered to the container 2 by a bonding agent, and though the other fixing methods than this are not shown, the bottom lid member 12 may be fastened to the container 2 by screws.

The elastic sheet member 5 of this embodiment has a convex surface projecting towards the inner side of the hollow part 6 and a flat surface facing the outer side, as is shown in FIG. 3(A), but it may be in any shape if only it is the shape with at least the inner circumferential portion 5a being thicker than the outer circumferential portion 5b. As such a shape, for example, the case in which both the side of the hollow part 6 and the outer side have convex surfaces as shown in FIG. 3(B), or the case in which the side of the hollow part 6 has the convex surface, and the outer side has a concave surface as shown in FIG. 3(C), or the like can be cited.

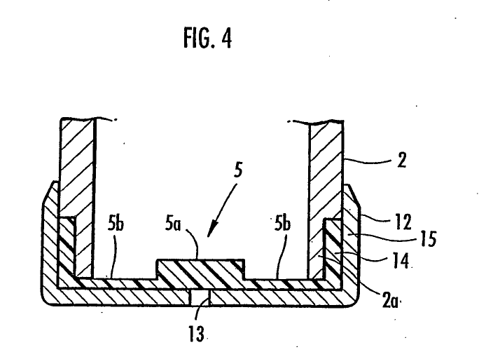

The elastic sheet member 5 may be in a shape in which the inner circumferential portion 5a thicker than the outer circumferential portion 5b is provided adjacent to the thinner outer circumferential portion 5b so as to form a step, as shown in FIG. 4.

In the first embodiment, the container 2 with the inner and outer surfaces thereof formed in a cylindrical shape is explained. However, at least the hollow part 6 of the container 2 must be cylindrically shaped, and the outer shape thereof may be any shape.

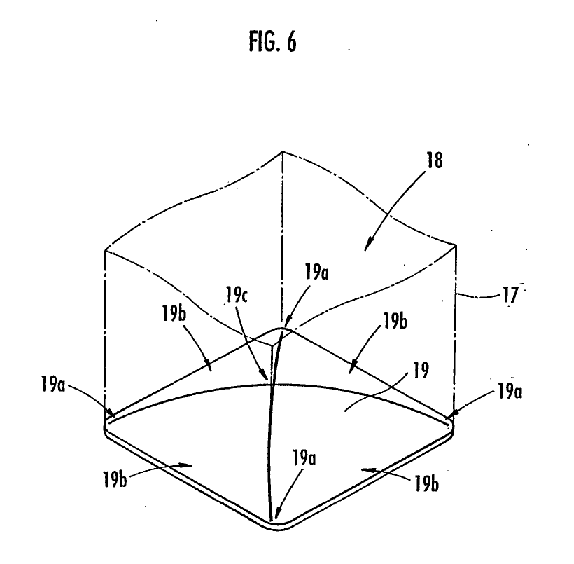

Next, a second embodiment of the present invention will be explained. In a delivering device 16 of the second embodiment, an outer shape of a container 17 is in a quadrangular column shape, and a hollow part 18 (refer to FIG. 6) which is formed inside the container 17 and houses a liquid is also formed into a quadrangular column shape. As shown in FIG. 6, an elastic sheet member 19 is formed in a quadrangular shape in plan view corresponding to a shape of a bottom portion of the hollow part 18, and it is formed into a shape gradually increasing in thickness toward a center portion from a perimeter edge portion as shown in FIG. 6. More specifically, the elastic sheet member 19 gradually increases in thickness from each linear edge 19b placed between respective corner portions 19a toward the respective corner portions 19a, and further increases in thickness toward a center portion 19c. That is, in a quadrangular-shaped elastic film member 19 as is described in the present embodiment, it becomes gradually thicker from its perimeter edge along its diagonal lines. Due to this, the elastic sheet member 19 expanding corresponding to a decrease of the liquid is smoothly brought into close contact with corner portions of the container 17 in the process of its expansion. The other structure is the same as the aforementioned first embodiment.

The elastic sheet member 19 expands into the hollow part 18 in the quadrangular column shape having the quadrangular shape in plan view, so that the elastic sheet member 19 is expanded in a quadrangular dome having a quadrangular bottom. Namely, the elastic sheet member 19 thus expanded is brought into close contact with an inner wall of the hollow part 18 from a side of each of the linear edges 19b between the respective corner portions 19a though it is not shown, and is brought into close contact with the respective corner portions 19a and inner corner portions of the hollow part 18 a little later. During this period of time, expansion in portions of the elastic sheet member 19, which are in close contact with the inner wall of the hollow part 18, is restrained by friction with the inner wall of the hollow part 18. On the other hand, portions of the elastic sheet member 19 (portions corresponding to the corner portions and the center portion 19c), which are not in close contact with the inner wall of the hollow part 18, are further expanded. In this state, since the elastic sheet member 19 is formed into such a shape as gradually increases in thickness toward the respective corner portions 19a from the linear edge portions 19b located between the respective corner portions 19a, and further increases in thickness toward the center portion as shown in FIG. 6, the portions which are brought into close contact with the inner wall of the hollow part 18 later can be expanded to a greater extent. Consequently, even when the elastic sheet member 19 is in the state in which it is expanded to a comparatively large degree as the amount of the liquid inside the hollow part 18 is decreased, the elastic sheet member 19 does not reach the expansion limit, so that the elastic sheet member 19 can expand further corresponding to the decrease of liquid, enabling smooth discharge of the liquid to the last drop.

In the second embodiment, the elastic sheet member 19, which is in such a shape as gradually increases in thickness from each of the linear edges 19b located between the respective corner portions 19a toward the respective corner portions 19a and further increases in thickness toward the center portion, is explained. However, any shape is suitable if only the elastic sheet member 19 is formed into the shape which is thicker at least in its center portion 19c than in the perimeter edge portion, and the elastic sheet member 19 may be in the same shape as the elastic sheet member 5 shown in FIG. 4 explained in the first embodiment.

In the second embodiment, the hollow part 18 inside the container 17, which is in the quadrangular column shape, is explained, but according to the present invention, the containers having the inner shapes of the other polygonal column shapes such as a triangular column shape and a hexagonal column shape may be adopted, though they are not shown. If the outer shape is formed into a polygonal column shape corresponding to the inner shape, aesthetic impression of the container can be improved further.

As for the container 17 shown according to the second embodiment, the container having an outer shape and inner shape thereof corresponding to each other is cited, but the outer shape of the container in the present invention is not limited to the polygonal column shapes. In this case, if the container is formed from a transparent material, the hollow part 18 in the polygonal column shape different from the outer shape of the container is visible from outside, and thereby aesthetic impression of the container can also be improved.

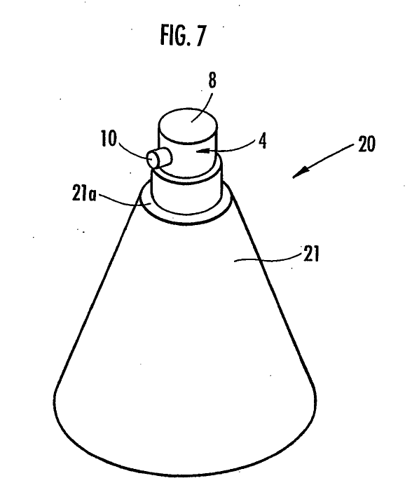

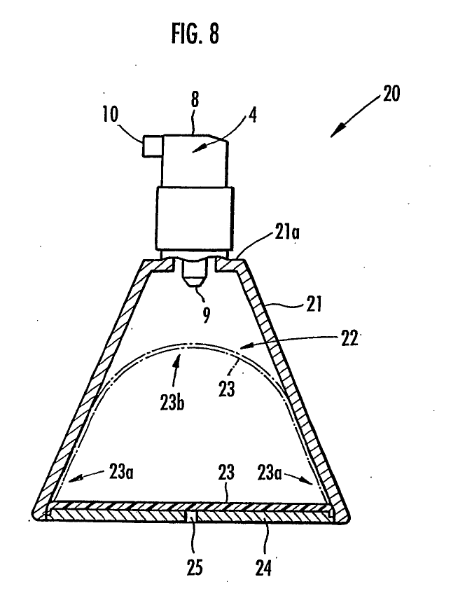

Next, a third embodiment of the present invention will be explained. In a delivering device 20 in the third embodiment, an outer shape of a container 21, and a shape of a hollow part 22 (refer to FIG. 8), which is provided inside the container 21, are substantially in a cone shape, as shown in FIG. 7. Pump means 4 is attached to a top portion 21a of the container 21, and as shown in FIG. 8, an elastic sheet member 23 for closing a bottom portion is provided at the bottom portion of the container 21. A bottom lid member 24 in a planar shape for covering the elastic sheet member 23 is further provided to an outer side (lower side) of the elastic sheet member 23. A communication hole portion 25 for introducing air into a space between the bottom lid member 24 and the elastic sheet member 23 is formed at the bottom lid member 24. Since the outer shape of the container 21 is substantially in a cone shape gradually expanding outward toward the bottom portion, it is extremely difficult for the container to be tipped over as compared with the containers in the circular cylinder shape or the polygonal column shape as in the first embodiment and the second embodiment, and also has also has an appearance excelling in aesthetic impression.

The pump means 4 has the same structure as that explained in the first embodiment, and therefore the explanation will be omitted. In the third embodiment, hydrogenated styrene elastomer is also adopted as the material of the elastic sheet member 23.

According to the delivering device 20, when a liquid inside the hollow part 22 is decreased first as a result of discharge by the pump means 4, the elastic sheet member 23 expands in a dome shape toward an upper part of the hollow part 22 in accordance with the decrease of the liquid as shown by the dot-and-dash line in FIG. 8. In this situation, air flows into the space between the elastic sheet member 23 and the bottom lid member 24 from the communication hole portion 25, and the elastic sheet member 23 is separated from the bottom lid member 24 and expanded smoothly.

Further, as the shape of the hollow part 22 of the container 21 is formed into a conical shape, the area of the bottom portion of the hollow part 22 is formed to be larger with respect to height of the hollow part 22. Due to this, the shape of the elastic sheet member 23 can be made larger with respect to the inner capacity of the hollow part 22, and therefore expansion limit of the elastic sheet member 23 can be made larger. Accordingly, even if the amount of the liquid inside the hollow part 22 becomes small and the elastic sheet member 23 is in the state in which it is expanded to a comparatively large degree, the elastic sheet member 23 does not reach the expansion limit, so that the elastic sheet member 19 can expand further corresponding to the decrease of the liquid, enabling smooth discharge of the liquid to the last drop.

Since the bottom lid member 24 is provided at the bottom portion of the container 21, the elastic sheet member 23 is prevented from being brought into contact with the outside of the container, and therefore even if the expansion of the elastic sheet member 23 is large and the elastic sheet member 23 becomes thin, the elastic sheet member 23 is prevented from breaking due to the contact from outside the container with certainty.

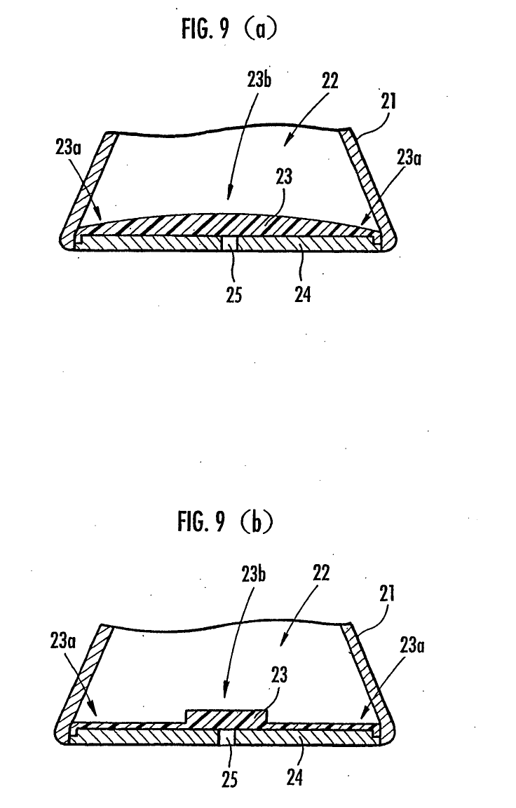

It is preferable that the elastic sheet member 23 is in the shape which is thicker at least in its center portion 23b than in its perimeter edge portion 23a. Specifically, as shown in sectional view in FIG. 9(A), it may be formed to be gradually thicker toward the center portion 23b from its perimeter edge portion 23a, or as shown in FIG. 9(B), the center portion 23b which is thicker than the perimeter edge portion 23a is provided adjacent to the thinner perimeter edge portion 23a so as to form a step. In doing as above, the expansion limit of the elastic sheet member 23 can be made larger. Namely, when the elastic sheet member 23 expands following the liquid decreased by being discharged by the pump means 4, the elastic sheet member 23 is gradually brought into close contact with the inner surface of the circumferential wall of the hollow part 22 from the perimeter edge portion 23a as shown in FIG. 8. In the portions of the elastic sheet member 23, which is brought into close contact with the inner surface of the hollow part 22, the expansion is restrained by the contact friction with the inner surface of the hollow part 22, but the center portion 23b of the elastic sheet member 23 is further expanded since it is not in contact with the inner surface of the hollow part 22. In this situation, a sufficient expansion amount can be obtained by making the center portion 23b of the elastic sheet member 23 thick, and the center portion 23b can be expanded well following the decrease in the liquid smoothly.

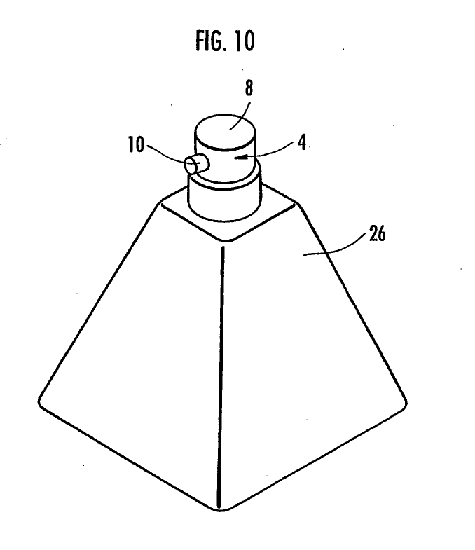

In the third embodiment, the container 21 of which inner shape is in the substantially conical form is explained, but as a fourth embodiment, a container 26 in which an outer shape and its inner shape (shape of the hollow part 22) are in a quadrangular pyramid shape (polygonal pyramid shape) can be adopted as shown in FIG. 10. Even if the shape of the hollow part 22 of the container 26 is a quadrangular pyramid or a polygonal pyramid other than this, the area of the bottom portion is formed to be larger with respect to the height of the hollow part 22, and therefore the elastic sheet member 23 has a larger shape with respect to the inner capacity of the hollow part 22. Accordingly, even when the amount of the liquid inside the hollow part 22 is decreased and the elastic sheet member 4 is in the state in which it is expanded to be comparatively large, the elastic sheet member 23 does not reach the expansion limit, so that the elastic sheet member 23 can expand further corresponding to the decrease of the liquid, enabling smooth discharge of the liquid to the last drop.

Though not shown, the elastic sheet member 23 becomes quadrangular corresponding to the shape of the bottom portion of the hollow part 22 in the quadrangular pyramid shape, and therefore the elastic sheet member 23 may be formed to be gradually thicker from the perimeter edge portion 23a to the center portion 23b correspondingly. Namely, explaining with reference to FIG. 8, if the shape of the hollow part 22 is a quadrangular pyramid, the close contact of the elastic sheet member 23 with the portion of the flat surface of the hollow part 22 occurs prior to the close contact of the elastic sheet member 23 with four corners inside the hollow part 22 in the process of expansion of the elastic sheet member 23. Due to this, expansion of the elastic sheet member 23 in close contact with the portion of the flat surface inside the hollow part 22 is restrained. In this state, by forming the elastic sheet member 23 to be gradually thicker corresponding to the shape of the bottom portion of the hollow part 22, a sufficient expansion amount can be obtained until the portions of the elastic sheet member 23 corresponding to the four corners of the hollow part 22 is brought into close contact with the four corners of the hollow part 22, and the elastic sheet member 23 can be expanded with good balance.

As for the containers 21 and 26 shown according to the third embodiment and the fourth embodiment, those each having the outer shape and the shape of the hollow part 22 corresponding to each other are cited, but the outer shape of the container in the present invention is not limited to the conical shape and the polygonal pyramid shape. In this case, if the container is formed from transparent material, the hollow parts 22 in the conical shape and the polygonal pyramid shape which are different from the outer shapes of the containers are visible from the outside, and thereby the aesthetic impression of the container can also be improved.

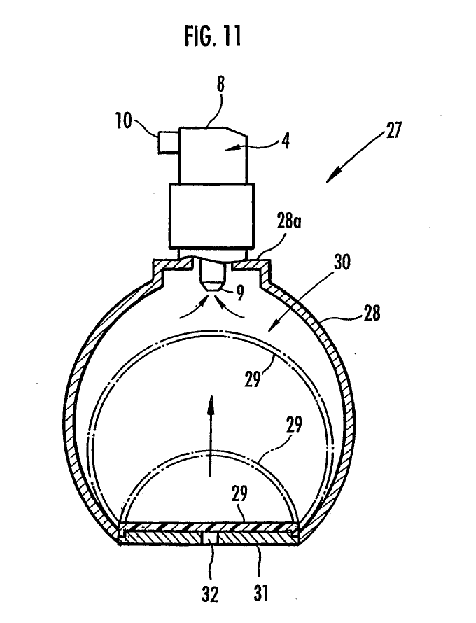

Next, a fifth embodiment of the present invention will be explained. A delivering device 27 of the fifth embodiment includes a container 28 in a substantially spherical shape, pump means 4 attached at a top portion 28a of the container 28, and an elastic sheet member 29, which is fixed to a bottom portion of the container 28 and blocks the bottom portion, as shown in FIG. 11. The bottom portion of the container 28 is flat, and a shape of a hollow part 30 included inside the container 28 is formed to be a substantially spherical shape corresponding to an outer shape of the container 28. A liquid is housed inside the hollow part 30. The shape of the hollow part 30 is formed to correspond to a shape of the elastic sheet member 29 when it is expanded to be a substantially spherical shape inside the hollow part 30 as will be described later. A planar bottom lid member 31 covering the elastic sheet member 29 is provided on an undersurface of the elastic sheet member 29 at the bottom portion of the container 28. A communication hole portion 32 for introducing air into a space between the bottom lid member 31 and the elastic sheet member 29 is formed at the bottom lid member 31.

The pump means 4 has the same structure as that explained in the first embodiment, and therefore the explanation will be omitted. In the fifth embodiment, hydrogenated styrene elastomer is also adopted as a material of the elastic sheet member 29.

Next, an operation of the delivering device 27 of the fifth embodiment will be explained. According to the delivering device 1, the liquid is discharged by moving the pump means 4 up and down. When the liquid inside the hollow part 30 is decreased by the discharge, the elastic sheet member 29 expands in a substantially spherical shape toward an upper portion inside the hollow part 30 correspondingly as shown by the dot-and-dash line in FIG. 11. In this situation, air flows from the communication hole portion 32 into the space between the elastic sheet member 29 and the bottom lid member 31, and the elastic sheet member 29 is smoothly expanded.

Here, the aforementioned hollow part 30 is formed into the substantially spherical shape corresponding to the expanded shape (shown by the dot-and-dash line in FIG. 11) of the elastic sheet member 29. Consequently, the elastic sheet member 29, which is expanded to be in the substantially spherical shape following the decrease in the liquid inside the hollow part 30, is not brought into close contact with an inner wall of the hollow part 30 until the liquid inside the hollow part 30 hardly exists. When the elastic sheet member 29 is in close contact with the inner surface or the like of the hollow part 30 in its expansion process, the expansion of the contacting portions is restrained by the contact friction with the inner wall of the hollow part 30, but the shape of the hollow part 30 corresponds to the expanded shape of the elastic sheet member 29 as in the fifth embodiment, whereby the contact of the elastic sheet member 29 with the inner wall of the hollow part 30 in the expansion process of the elastic sheet member 29 is extremely small. Accordingly, the elastic sheet member 29 expanding inside the hollow part 30 is expanded substantially uniformly without resistance, so that the elastic sheet member 29 can expand corresponding to the decrease of the liquid, enabling smooth discharge of the liquid to the last drop.

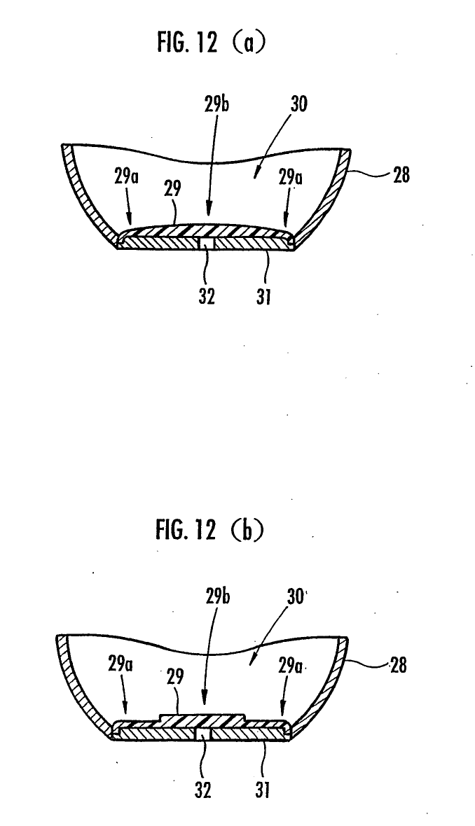

It is preferable that the elastic sheet member 29 is formed into the shape which becomes thicker at least in a center portion 29b than a perimeter edge portion 29a. Specifically, it may be formed to be gradually thicker toward the center portion 29b from its perimeter edge portion 29a, as shown in the sectional view in FIG. (A), or it may be in the shape in which the center portion 29b thicker than the perimeter edge portion 29a is provided adjacent to the thinner perimeter edge portion 29a so as to form a step, as shown in FIG. 12(B). In doing so, the expansion limit can be made larger. Specifically, when the elastic sheet member 29 is expanded following the liquid decreased by being discharged by the pump means 4, the center portion 29b is expanded to a larger extent than its perimeter edge portion 29a. In this situation, a sufficient expansion amount can be obtained by making the center portion 29b of the elastic sheet member 29 thicker, and the elastic sheet member 29 can be expanded well following the decrease in the liquid smoothly.

As for the container 28 in the fifth embodiment, it is extremely easy to form the outer shape into the substantially spherical shape corresponding to the inner shape as shown in FIG. 11, thus making it possible to produce an aesthetic impression on the sense of sight.

In the container 28 shown according to the fifth embodiment, the outer shape and the shape of the hollow part 30 are formed into substantially spherical shapes corresponding to each other, but the present invention is not limited to this, and a shape different from the hollow part 30 in the substantially spherical shape may be the outer shape of the container though not shown. In this case, if the container is formed from transparent material, the substantially spherical hollow part 30 is visible from the outside, and this can also improve the aesthetic impression of the container.

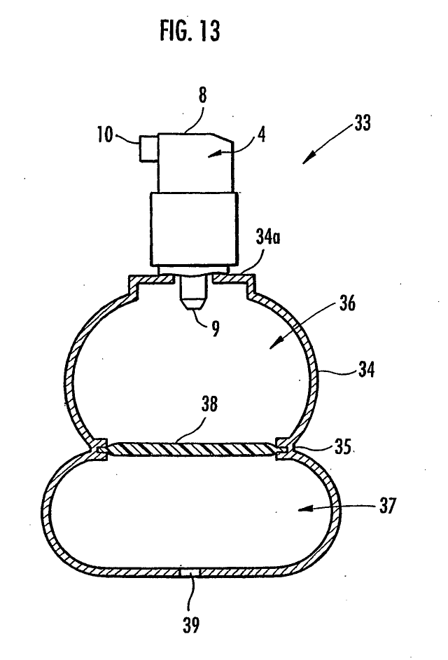

Next, a sixth embodiment of the present invention will be explained. A delivering device 33 of the sixth embodiment is comprised of a container 34 having a hollow inner shape corresponding to an outer shape of the container, and pump means 4 attached at a top portion 34a of the container 34, as shown in FIG. 13. In the container 34, a reduced diameter portion 35 is formed at the entire circumference of a substantially center portion as shown in the drawing, so that the container 34 is formed into a so-called gourd shape which looks like a pair of spheres combined together. In the inside of the container 34, an upper part (substantially upper half part) of the reduced diameter portion 35 is a substantially spherical first hollow part 36, a lower part (substantially lower half part) via the reduced diameter portion 35 is a second hollow part 37 including a flat bottom portion. An elastic sheet member 38 which blocks the first hollow part 36 and is freely expandable is provided at a portion between the first hollow part 36 and the second hollow part 37 which is located at the reduced diameter portion 35.

The elastic sheet member 38 divides the first hollow part 36 and the second hollow part 37 in a substantially flat form in a state in which the container 34 is vacant, and blocks the fist hollow part 36 in a sealed state. When a liquid is charged into the container 34, the liquid is housed inside the first hollow part 36 blocked by the elastic sheet member 38, then the elastic sheet member 38 expands along an inner surface of the second hollow part 37, and the liquid is housed inside the elastic sheet member 38.

The aforementioned pump means 4 has the same structure as explained in the first embodiment, and therefore the explanation will be omitted. In the sixth embodiment, hydrogenated styrene elastomer is also adopted as a material of the elastic sheet member 38. A communication hole portion 39 for introducing air into a space between the second hollow part 37 and the elastic sheet member 38 is formed at a bottom portion of the second hollow part 37 of the container 34.

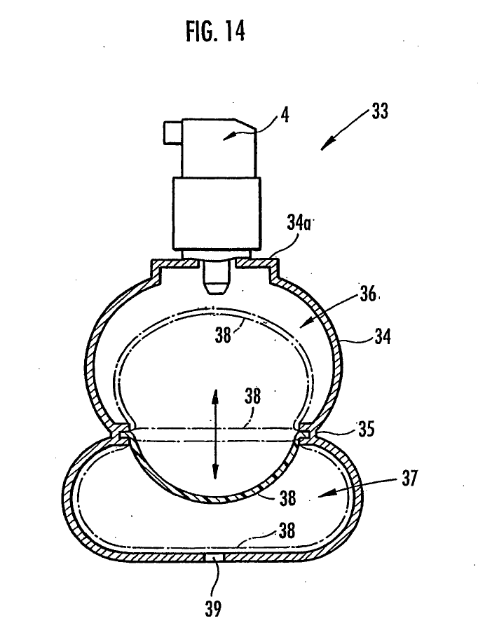

Next, an operation of the delivering device 33 of the sixth embodiment will be explained. According to the delivering device 33, the liquid can be discharged by moving the pump means 4 up and down. When the liquid inside the container 34 is decreased by the discharge, the elastic sheet member 38 inside the second hollow part 37 contracts correspondingly and is separated from the inner surface of the second hollow part 37 as shown in FIG. 14, and is temporarily returned to the planar shape between the first hollow part 36 and the second hollow part 37. In this situation, air flows into the space between the elastic sheet member 38 and the second hollow part 37 from the communication hole portion 39, and the elastic sheet member 38 is smoothly contracted.

When the liquid inside the container 34 is further decreased, the elastic sheet member 38 expands in a substantially spherical shape toward the inside of the first hollow part 36, so that the elastic sheet member 38 can expand corresponding to the decrease of the liquid, enabling smooth discharge of the liquid to the last drop.

The first hollow part 36 in the container 34 of the sixth embodiment is formed into the substantially spherical shape. Consequently, it substantially corresponds to the expanded shape of the elastic sheet member 38. According to this, the contact of the elastic sheet member 38 with an inner surface of the first hollow part 36 in the expansion process of the elastic sheet member 38 is extremely small, and the elastic sheet member 38 expanding inside the first hollow part 36 is expanded substantially uniformly from its perimeter edge portion to a center portion without resistance, thus making it possible to perform discharge of the liquid smoothly.

When the elastic sheet member 38 is in close contact with the inner surface or the like of the container in its expansion process, it is restrained from expanding due to contact friction. Thus, by forming the elastic sheet member 38 into a shape which is thicker at least in its center portion 38a than in a perimeter edge portion 38b, the expansion limit can be made larger. Namely, when the elastic sheet member 38 expands following the liquid decreased by the discharge, even if the perimeter edge portion 38b of the elastic sheet member 38 comes into close contact with an inner surface of a circumferential wall of the first hollow part 36, the center portion 38a of the elastic sheet member 38 is not in contact with the inner surface of the first hollowpart 36, and therefore a sufficient expansion amount can be obtained.

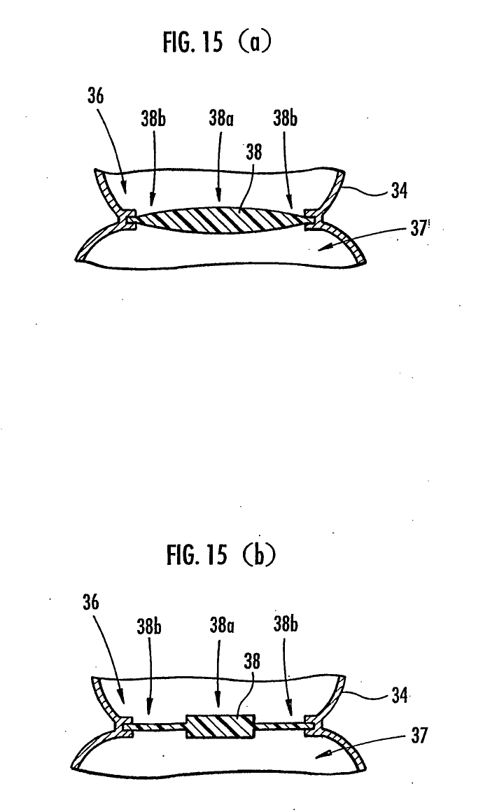

The elastic sheet member 38 including the aforementioned shape may be formed to be gradually thicker from its perimeter portion 38b toward the center portion 38a as shown in the sectional view in FIG. 15(A), or it may be formed into a shape in which the center portion 38a, which is thicker than the perimeter portion 38b, is connected provided adjacent to the thinner perimeter portion 38b so as to form a step, as shown in FIG. 15(B).

By providing the elastic sheet member 38 at a border position between the fist hollow part 36 and the second hollow part 37, all the liquid inside can be efficiently discharged without being influenced by the shapes of the first hollow part 36 and the second hollow part 37. Though not shown, for example by making the shapes of the first hollow part 36 and the second hollow part 37 different from each other, and providing the elastic sheet member 38 at their border position, the container is made suitable for housing a perfume and cosmetics with a fine aesthetic impression.

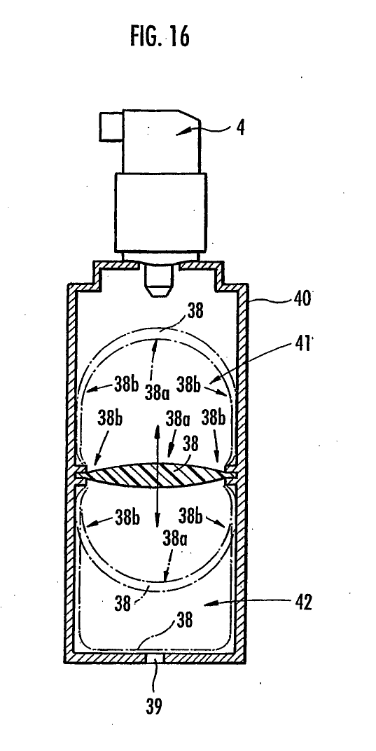

In the sixth embodiment, the delivering device including the reduced diameter portion 35 at the border position between the first hollow part 36 and the second hollow part 37 of the container 34 is explained, and other than this, the one in which a container 40 is formed into a circular cylinder shape, and a first hollow part 41 and a second hollow part 42 are formed into a continuous circular cylinder shape, for example, as shown in FIG. 16, can be cited. In this case, unlike the aforementioned first hollow part 41 in the substantially spherical shape, the contact area of the elastic sheet member 38 with an inner circumferential surface of the first hollow part 41 and an inner circumferential surface of the second hollow part 42 following the expansion becomes comparatively large. Thus, as described above, by forming the elastic sheet member 38 into a shape in which at least its center portion 38a is thicker than the perimeter edge portion 38b, an expansion amount of the center portion 38a, at which the contact with the inner circumferential surface of the first hollow part 41 and the inner circumferential surface of the second hollow part 42 becomes small, is sufficiently secured, and therefore the liquid can be smoothly discharged. In addition, the elastic sheet member 38 is at the border position between the first hollow part 41 and the second hollow part 42, so that when the liquid is charged in the entire container 40, the elastic sheet member 38 is in an expanded state inside the second hollow part 42. When the liquid is decreased, it expands inside the first hollow part 41. Therefore it can be made to follow the decrease in the liquid inside with an expansion amount of about ½ of the capacity of the container 40, thus making it possible to prevent breakage or the like of the elastic sheet member 38 and discharge the liquid smoothly even if the container is formed to be long and narrow in the height direction to improve excellence in design, for example.

As described above, by adopting the structure of the present invention, not only the liquid inside the container can be smoothly discharged, but also the excellence in design of the container can be easily improved.

As for the containers 34 and 40 shown according to each of the above-described embodiments, those with the outer shapes and inner shapes corresponding to each other are cited, but the outer shapes of the containers in the present invention are not limited to the shapes such as the gourd shape and the circular cylinder shape. In this case, if the container is formed from transparent material, the inside with a different shape from the outer shape of the container is visible from the outside, and the aesthetic impression of the container can be improved.

### INDUSTRIAL APPLICABILITY

The present invention makes it possible to discharge liquid while reliably maintaining the sealed state of the container, and therefore it is suitable as a container for housing a liquid chemical which is easily deteriorated by contacting outside air. Moreover, it is possible to adopt the container with excellent design, and therefore it is suitable as the container for housing a liquid aromatic, a perfume, a hair styling liquid, a liquid cosmetic or the like.

1. A delivering device for discharging a liquid housed in a container by pump means provided to the container,
wherein said container comprises a hollow part for housing said liquid, and an elastic sheet member for blocking the hollow part, said elastic sheet member being expandable toward the inner side of said hollow part in a dome shape while gradually becoming thin corresponding to the decrease of the liquid inside said hollow part, when liquid is discharged by said pump means.

2. The delivering device according to claim 1,
wherein said elastic sheet member is provided at a bottom side of said container to block said hollow part, and is expandable along an inner circumference wall surface of the hollow part following the decrease of the liquid inside the hollow part.

3. The delivering device according to claim 1,
wherein said elastic sheet member comprises a hydrogenated styrene elastomer.

4. The delivering device according to claim 1,
wherein said pump means comprises a pump portion located inside said container for sucking up the liquid therein, and a pressing portion comprising a discharge port for discharging the liquid sucked by said pump portion and actuating the pump portion by pressing operation,
said container comprises a pump mounting portion for mounting said pump means, and
said pump mounting portion comprises a pump housing portion for housing the pump portion of the pump means, said pump portion located inside the container, in a position so as to prevent the elastic sheet member expanding inside the hollow part from coming into contact with the pump portion.

5. The delivering device according to claim 1,
wherein said container comprises a lid member for covering an outer side of said elastic sheet member, and the lid member comprises a communication hole portion for communicating with an outer side of the container and a side opposing the elastic sheet member so as to pass air freely.

6. The delivering device according to claim 1,
wherein said container is formed of a transparent material.

7. The delivering device according to claim 1,
wherein a shape of said hollow part of the container is formed into a cylindrical shape.

8. The delivering device according to claim 1,
wherein a shape of said hollow part of the container is formed into a polygonal column shape.

9. The delivering device according to claim 1,
wherein a shape of said hollow part of the container is formed into a circular cone shape gradually enlarging toward a bottom portion.

10. The delivering device according to claim 1,
wherein a shape of said hollow part of the container is formed into a polygonal pyramid shape gradually expanding toward a bottom portion.

11. The delivering device according to claim 1,
wherein said elastic sheet member blocks a part of said hollow part and expands in a substantially spherical shape toward the inside of the hollow part as the liquid inside the hollow part is decreased by being discharged therefrom, and
wherein a shape of said hollow part of the container is formed into a substantially spherical shape corresponding to an expanded shape of said elastic sheet member.

12. The delivering device according to claim 1,
wherein said elastic sheet member is provided at a bottom portion of said container and formed into a shape corresponding to an inner circumference shape of the bottom portion, and
at least a center portion thereof is formed to be thicker than a perimeter edge portion thereof.

13. The delivering device according to claim 8,
wherein said elastic sheet member corresponding to the inner circumferential shape of said hollow part becomes gradually thicker from each linear edge between corner portions to respective corner portions, and further becomes gradually thicker from the respective corner portions toward a center portion.

14. The delivering device according to claim 1,
wherein said container comprises a first hollow part which is formed at a substantially upper half portion thereof and capable of housing said liquid, and a second hollow part which is formed at a substantially lower half portion thereof and capable of housing said liquid,
said elastic sheet member for blocking said first hollow part is provided at a border position between said first hollow part and said second hollow part,
said second hollow part is provided with a communication hole portion capable of introducing air into the second hollow part from outside thereof,
the liquid is housed inside said elastic sheet member expanding into the second hollow part inside said second hollow part, and
the elastic sheet member, corresponding to the decrease of the liquid inside the container, is contracted in the interior of the second hollow part, and is expanded toward a top portion of the container in the interior of the first hollow part, when the liquid is discharged by said pump means.

15. The delivering device according to claim 14,
wherein a reduced diameter portion with a diameter being reduced is formed on an entire circumference of an inner circumference wall at a border position between said first hollow part and said second hollow part, and said elastic sheet member is provided at the reduced diameter portion.

16. The delivering device according to claim 14 or claim 15,
wherein said elastic sheet member is formed to be thicker at least in a center portion thereof than in a perimeter edge portion thereof.

17. The delivering device according to claim 10,
wherein said elastic sheet member corresponding to the inner circumferential shape of said hollow part becomes gradually thicker from each linear edge between corner portions to respective corner portions, and further becomes gradually thicker from the respective corner portions toward a center portion.

18. The delivering device according to claim 15,
wherein said elastic sheet member is formed to be thicker at least in a center portion thereof than in a perimeter edge portion thereof.
